(19) United States
(12) Patent Application Publication
(10) Pub. No.: US 2017/0024230 A1
(43) Pub. Date: Jan. 26, 2017

(54) METHOD, APPARATUS, AND COMPUTER-READABLE MEDIUM FOR OFUSCATING EXECUTION OF AN APPLICATION ON A VIRTUAL MACHINE

(71) Applicants: Yunpeng LI, Beijing (CN); Wilson QIE, Beijing (CN); Shiya LIU, Beijing (CN); Tony CHEN, Beijing (CN); Irdeto B.V., Hoofddorp (NL)

(72) Inventors: Yunpeng Li, Beijing (CN); Wilson Qie, Beijing (CN); Shiya Liu, Beijing (CN); Tony Chen, Beijing (CN)

(21) Appl. No.: 15/300,944

(22) PCT Filed: Mar. 31, 2014
(86) PCT No.: PCT/CN2014/074356

§ 371 Date: Sep. 30, 2016

(51) Int. Cl. G06F 9/455; G06F 9/45

(52) U.S. Cl. CPC G06F 9/45508; G06F 8/41

(57) ABSTRACT

An apparatus, computer-readable medium, and computer-implemented method for obfuscating execution of an application on a virtual machine (VM), includes receiving a custom VM definition corresponding to a custom VM, generating custom application bytecode from application source code based at least in part on the custom VM definition, the custom application bytecode being configured to run on the custom VM, generating custom VM source code based at least in part on the custom VM definition, compiling the custom VM source code with one or more target system compilers to generate one or more instances of the custom VM, the one or more instances of the custom VM being configured to run on the one or more target systems, and packaging the custom application bytecode and the one or more instances of the custom VM into an installable application.

### BACKGROUND

Software applications often require some adaptation in order to be suited for execution on a different platform. The process of modifying software to run on a different platform is known as “porting” and requires an understanding of each hardware platform. Differences in CPU, Operating System, Graphical User Interface or Standard Libraries can require significant changes to the software code and can require a compiler or linker to generate a new executable for each different platform. As a result, maintaining portability of an application over a large number of seemingly close platforms can be a difficult task.

A process virtual machine (VM) enables software developers to focus on a single “virtual machine” platform, thereby enabling developers to maintain portability of the software across multiple platforms, each of which can run a version of the virtual machine. A typical VM development flow is illustrated in FIG. 1A. As shown in the figure, application source code 101 is compiled on a VM compiler which generates the application binary code 103. The application binary code 103 can be thought of as virtual machine code and contains instructions which are then interpreted and executed by the VM as shown at 104.

Some well-known virtual machines are the Java Virtual machine (JVM) or the Common Language Runtime. The virtual machine development flow for the Java Virtual machine is shown in FIG. 1B. Source code 111 is compiled by the JVM compiler to generate a set of instructions executable on the JVM, also referred to as Java bytecode 113 because the size of each of the instructions in the executable code is one byte. The bytecode is then executed on the JVM 114, which interprets and executes the instructions in the bytecode.

The virtual machine application effectively hides all of the platform differences, so only a single application (the virtual machine itself) needs to be adapted to all platforms. This is particularly useful for mobile devices such as mobile phones and tablet computers where the competition has resulted in a wide range of computing platform differences. VM's can also be used in combination with digital TV content as described in U.S. Patent Application Publications US 2004/0133794 A1 and US 2008/0101604 A1.

Many virtual machines, such as the JVM, utilize Just-In-Time compilation (JIT), which is compilation done during execution of a program—at run time—rather than prior to execution. A JIT compiler can read the bytecode in many sections (or in full) and compile them dynamically into machine language so the program can run faster. The code can be compiled when it is about to be executed (hence the name “just-in-time”), and then cached and reused later without needing to be recompiled. Although the use of Virtual machines can result in a performance penalty, Just-In-Time compiler optimizations enable VMs to achieve acceptable performance compared to native execution in most cases. One implementation of JIT compilation is to first have Ahead-Of-Time (AOT) compilation of the application source code to bytecode (virtual machine code), known as bytecode compilation, and then have JIT compilation to machine code (dynamic compilation).

FIG. 1C shows some of the functional components in a JVM 122 which executes the bytecode 121. The Class Loader loads the Java bytecode for a particular class of the Java application and verifies the bytecode integrity before transferring control to the execution functional elements formed by the VM interpreter and the JIT compiler. The memory manager module controls access to the data structures and implements the dynamic memory functions.

Java API and Runtime Libraries provide Java applications with the ability to use common library functions and to access other resources in the native computing environment. The collection of all these functions is often called the Java Runtime Environment (JRE). FIG. 1D shows a schematic diagram for a JRE 132 which executes the bytecode 131.

With the JRE, the Java Application can implement any function that a native application may implement. In some cases, it is difficult or inconvenient to implement certain features using only features supported in the JRE. For those features, the Java Native Interface (JNI) provides the ability to interface to native applications (e.g. compiled C or C++ applications). FIG. 1E illustrates the schematic diagram for the JNI, which is part of the JRE 142 that executes the bytecode 141 and interfaces with the operating system 144, hardware 145, and native application 143.

Android™ is a well-known operation system designed primarily for touch screen mobile devices such as smartphones and tablet computers. Android application package file (APK) is the file format used to distribute and install application software and middleware onto the Android operating system. To make an APK file, a program for Android is first compiled, and then all of its parts are packaged into one file. This holds all of that program's bytecode (such as .dex files), resources, assets, certificates, and manifest file, and APK files are ZIP file formatted packages based on the Java Archive (JAR) file format.

An APK file is an archive that usually contains the following files and folders:
META-INF directory containing:
   MANIFEST.MF: the Manifest file,
   CERT.RSA: The certificate of the application,
   CERT.SF: The list of resources and SHA-1 digest of the corresponding lines in the MANIFEST.MF file,
lib: the directory containing the compiled code that is specific to a software layer of a processor, the directory is split into more directories within it:
   armeabi: compiled code for all ARM based processors only,
   armeabi-v7a: compiled code for all ARMv7 and above based processors only,
   x86: compiled code for x86 processors only,
   mips: compiled code for MIPS processors only,
res: the directory containing resources not compiled into resources.arsc,
assets: a directory containing applications assets, which can be retrieved by AssetManager,
AndroidManifest.xml: An additional Android manifest file, describing the name, version, access rights, referenced library files for the application. This file may be in Android binary XML that can be converted into human-readable plaintext XML with tools such as AXMLPrinter2, apktool, or Androguard,
classes.dex: The classes compiled in the dex file format understandable by the Dalvik virtual machine, and
resources.arsc: a file containing precompiled resources, such as binary XML for example.

The “classes.dex” file is the most important file in an APK. Each APK has precisely one ‘classes.dex’ file. The list above shows that the entire program's Java code is contained in the classes.dex file. For portability reasons, programs for Android devices are commonly written in Java and compiled to bytecode (which is contained in the .class file). The compiled bytecode then is converted from Java Virtual machine-compatible .class files to the Dalvik-compatible.dex (Dalvik Executable) files to enable installation on a mobile device.

The Java bytecode (i.e. the .class file) is a binary format that represents the instructions that the Java virtual machine executes. FIG. 1F illustrates an example of three lines of Java bytecode 150 based on the Java VM instruction set and including three instructions, 151, 152, and 153. The numerals on the left indicate the byte address for each instruction. For example, the first instruction 151 is at byte number 0, the second instruction 152 is at byte number 3, and the third instruction 153 is at byte number 4. Some instructions may take operands. For example, the first instruction “sipush” 151 pushes a short value indicated by operand 150 onto the stack. Since the operand takes up two bytes (bytes 1 and 2), the next instruction 152 starts at byte 3.

Unfortunately, a lot of information that is present in a Java source code file will frequently be contained in the bytecode. This includes information about classes, methods, fields, and source code such as through a “LineNumberTable” which relates instructions to specific lines of source code and a “StackMapTable” which is used to verify variable types. Reverse engineering tools such as decompilers benefit from this additional embedded information to increase the output quality of the decompiled source code.

One technique for combating reverse engineering is software obfuscation. Software obfuscation techniques can make reverse engineering of a protected software application very difficult. However, high degrees of obfuscation result in a significant performance penalty. This specifically applies to software applications that operate in a virtual machine, which itself introduces a performance penalty. The combined performance penalty caused by software obfuscation and execution on a virtual machine can be difficult to overcome in resource constrained platforms such as mobile devices. Hence, the degree of software obfuscation protection is often limited to achieve an acceptable performance.

As described earlier, it is desirable for an application to be easily portable to a broad range of platforms such as mobile devices based on the Android OS. This can be accomplished through the use of a virtual machine, which also simplifies testing of the functionality of applications. However, as Android is based on Open Source Software, it is easy for an attacker to produce a modified virtual machine based on the VM source code and use the modified virtual machine to reverse engineer the application.

Since performance constraints often limit the degree of obfuscation that is available to secure a Java application, such as a mobile game or app, this frequently means that secured applications do not have the desired level of protection needed for a white-box attack scenario (i.e. a scenario in which the code is available and accessible). This lack of protection makes reverse engineering a Java application from bytecode more feasible than is often desirable.

Merely encrypting bytecode and decrypting it prior to execution on a JVM is problematic, as attackers can replace the JVM with a modified JVM and observe and intercept the bytecode after the loading stage (after it has been decrypted). Additionally, any secured external application also needs to work with a standard JVM (or JRE), which an attacker can modify in order to obtain a clear text version for the entire Java bytecode of the Java application.

### BRIEF DESCRIPTION OF THE DRAWINGS

FIGS. 1A-1B illustrate development flows for execution of applications on virtual machines.

FIGS. 1C-1E illustrate components of the Java virtual machine, Java runtime environment, and Java native interface.

FIG. 1F illustrates a Java bytecode sample.

FIG. 1G illustrates a development flow for high-level obfuscation and execution of an application on a Java virtual machine.

FIG. 2 illustrates a flowchart for obfuscating execution of an application on a virtual machine according to an exemplary embodiment.

FIG. 3 illustrates a development flow for obfuscating execution of an application on a virtual machine according to an exemplary embodiment.

FIG. 4 illustrates components of a virtual machine compiler according to an exemplary embodiment.

FIG. 5 illustrates components of a virtual machine code generator according to an exemplary embodiment.

FIG. 6A illustrates an example of a high-level obfuscation transformation according to an exemplary embodiment.

FIGS. 6B-6D illustrate an example of bytecode corresponding to application source code according to an exemplary embodiment.

FIGS. 7A-7B illustrate an example of special instructions which can be implemented using a custom virtual machine interpreter and custom application bytecode according to an exemplary embodiment.

FIG. 8 illustrates an encryption transformation performed on application bytecode according to an exemplary embodiment.

FIG. 9 illustrates an instruction address transformation performed on the application bytecode according to an exemplary embodiment.

FIG. 10 illustrates a data location transformation implemented by the custom virtual machine according to an exemplary embodiment.

FIG. 11 illustrates a data value transformation implemented by the custom virtual machine according to an exemplary embodiment.

FIG. 12 illustrates an exemplary computing environment that can be used to carryout the method for obfuscating execution of an application on a virtual machine according to an exemplary embodiment.

### DETAILED DESCRIPTION

While methods, apparatuses, and computer-readable media are described herein by way of examples and embodiments, those skilled in the art recognize that methods, apparatuses, and computer-readable media for obfuscating execution of an application on a virtual machine are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

There is a need for bytecode obfuscation techniques which protect against observation of the instructions contained in the bytecode and which do not place significant performance constraints on the execution of the application by a virtual machine.

There are several security techniques used to protect a Java software application that make it hard for an attacker to obtain or modify the Java bytecode. For example, the Java software application can be secured, or software obfuscation techniques can be used to protect the Java software application using source code and/or compile time software transformations. These high level obfuscation techniques achieve their obfuscation properties without relying on the characteristics of the target processor(s).

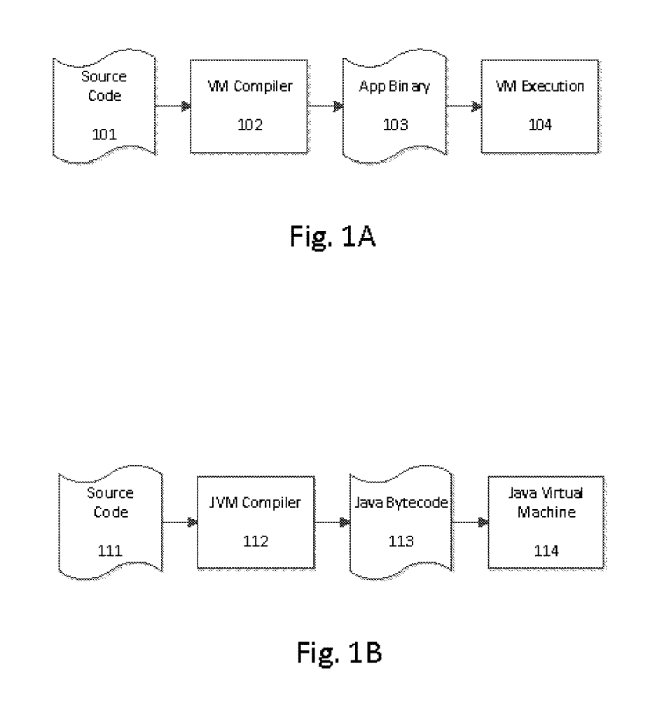

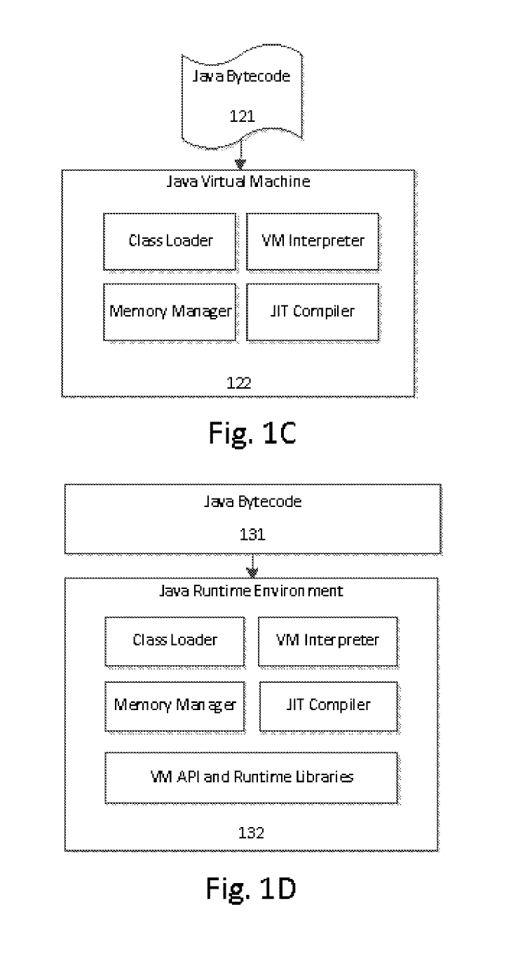

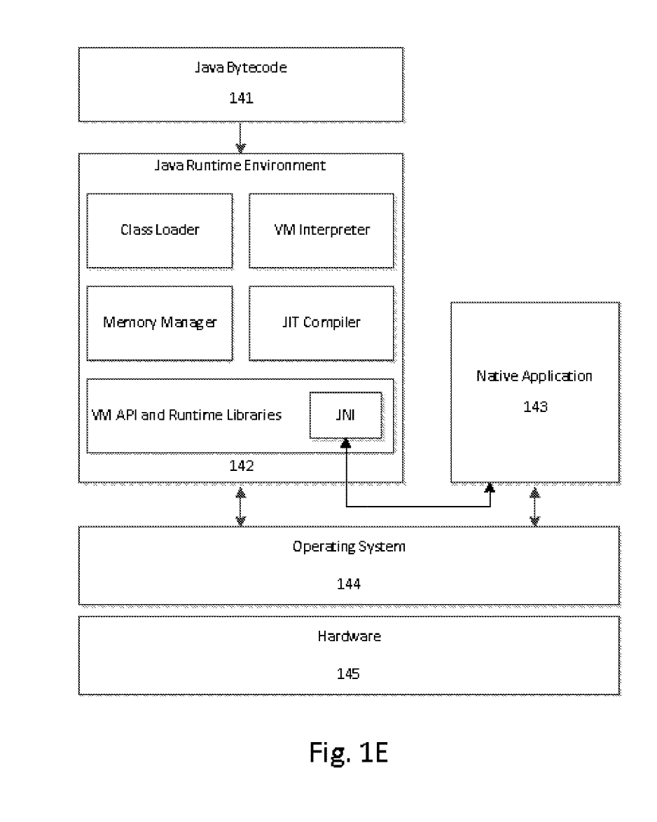

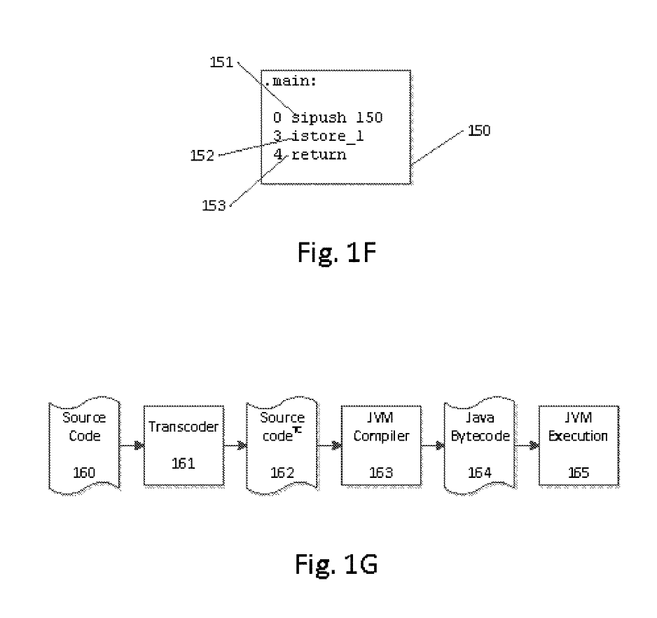

FIG. 1G shows a diagram of the process flow for obfuscating source code. The source code 160 is provided to a transcoder 161, which implements the high level obfuscation of the source code 160 to produce obfuscated source code 162. This obfuscated source code 162 maintains the semantics of the original software while making the final representation as unintelligible as possible. The obfuscated source code 162 is then compiled by a JVM compiler 163 to generate the Java bytecode 164 which is executed on the JVM 165.

In addition to obfuscation of high level code, the VM instruction set in the bytecode can be encrypted or obfuscated and then the encrypted instructions can be decrypted during loading of the application (by the bytecode loader) or during the execution of an instruction by the VM. U.S. Patent Application Publication US 2012/0246487 A1, the contents of which are hereby incorporated by reference, describes a secured native code module that uses the JNI to establish a close link to the JVM. The secured application implements code transformations in a special class loader as well as several other security functions.

The tool chain of the diagram in FIG. 1G shows the steps of converting the source code into an obfuscated version of the source code, which is compiled and linked into a Java virtual machine binary, that is, a representation of the obfuscated logic according to the Java Bytecode instruction set. This sequence of steps replaces multiple tool chains of this type each transforming the source code into an obfuscated binary (in the native instruction set) for a specific target platform.

However, as discussed earlier, high degrees of source code obfuscation result in a significant performance penalty and do not protect the application from reverse engineering via the instructions in the resulting bytecode, which can be observed and exploited through a modified virtual machine. Furthermore, encryption of bytecode and decryption prior to loading in a VM also does not adequately protect the resulting bytecode, which can be observed in decrypted form after loading.

Applicant has discovered and developed a secured (or obfuscated) custom virtual machine (custom VM), such as a custom Java VM, that is made incompatible with a standard version of the Java VM application by the inclusion of additional security functionality that protects against the observation of the instructions in the bytecode.

The obfuscation protection can be applied to an entire VM application or to parts of the VM application. Throughout the disclosure, reference is made to a Java VM, but the methods and systems described herein can be utilized with other types of virtual machines as well.

The custom VM can use a different (transformed) instruction set, which requires a modified loader and/or runtime bytecode fix-ups in order to execute, and thereby protects any customized application bytecode from white-box reverse engineering, since the customized bytecode would not execute properly on a non-custom VM. The bytecode generated for an application can be customized based on the custom VM definition. For example the customized bytecode format can be extended and the extended instructions can be mapped to a sequence of non-extended bytecodes during execution by the custom VM. The extended instructions can also be processed by a secured JIT compiler to generate native instructions to implement the desired operation(s).

A memory manager that is part of the custom VM can implement non-standard functions that the customized application bytecode relies on for proper operation. Additionally, a custom VM interpreter that is part of the custom VM can be secured and can support non-standard functions such as a decryption step of part of the fetch-execute cycle. The custom VM interpreter can also provide tracing information to a class loader and/or an instruction verifier in order to detect abnormal program execution traces. The custom application bytecode can additionally contain instruction traces that trigger hidden functionality within the custom VM interpreter.

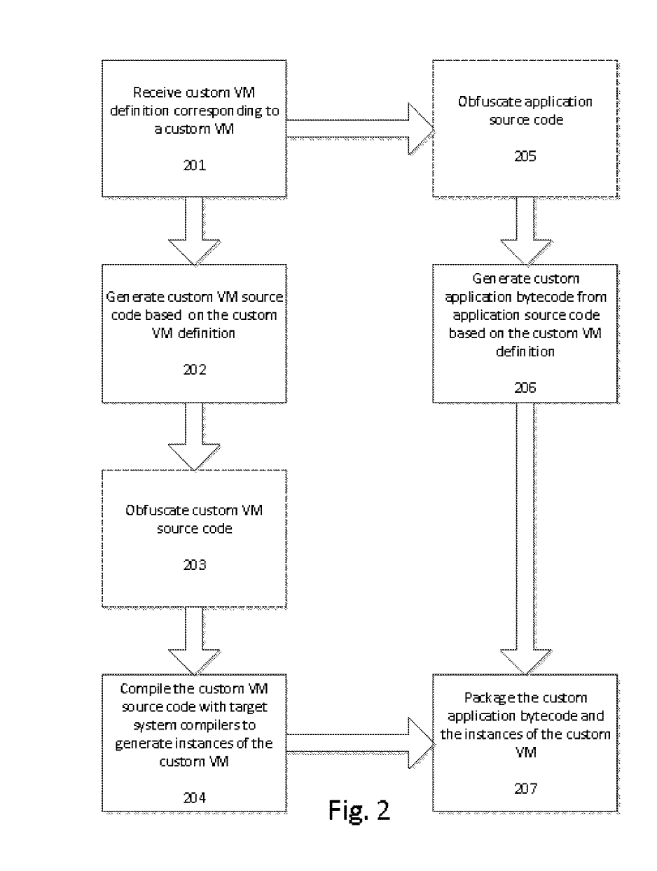

FIG. 2 is flowchart showing a method for obfuscating execution of an application on a VM according to an exemplary embodiment. At step 201 a custom VM definition corresponding to a custom VM is received. The custom VM definition can be a file that describes a specific Virtual machine or variants of an existing Virtual machine. For example, the custom VM definition can specify a unique custom VM. The custom VM definition will be used to create the custom VM, including the custom VM interpreter which interprets custom application bytecode designed for the custom VM, as well as the custom VM compiler which will compile the application source code into the custom application bytecode.

At step 202 custom VM source code is generated based at least in part on the custom VM definition. At step 203, the custom VM source code can optionally be obfuscated or secured, such as by using the high level obfuscation and/or security techniques described earlier. For example, obfuscation techniques include simple keyword substitution, use or non-use of whitespace to create artistic effects, and self-generating or heavily compressed programs.

Other high-level obfuscation and/or security techniques that can be used include control flow transformations, branch protection, routine in-lining, control flow flattening, white-box cryptography, integrity verification modifications, anti-debugging modifications, and/or secure packaging/loading. These are described in greater detail below.

Control flow transformations. Control flow refers to the execution path followed as programs run and control is transferred to various blocks of statements. Control flow transformation secures a program by randomizing the block bodies of the target source code. This results in code that is extremely difficult to trace, and thus vastly increases the cost to the attacker who is attempting to reverse engineer the flow of the application.

Branch protection. In software, instructions that potentially transfer control to another instruction are referred to as “branches.” A conditional branch is a branch whose destination is determined by its input value(s), and include IF statements, SWITCH statements, and conditional operators. Attackers typically try to jam or bypass important branches in the code in order to sidestep security checking or in an attempt to modify the original flow of the program. Branch protection prevents branch jamming by adding code that causes the program to behave incorrectly if the branch is jammed.

Routine in-lining. In this technique, separate logical sections of code within a file are merged before transforms are applied. This approach is different from compiler in-line options, which are done after pre-processing. The goal is to combine operations and obscure the logic of the program.

Control flow flattening. Compilers implement the control flow of procedural languages using a fixed set of jump and conditional branch instructions of the target instruction-set. Generally, the flow-of-control is achieved in machine code using a systematic or rule-driven approach. Control constructs are translated into canned and predictable instruction sequences. Consequently, reverse-engineering tools such as decompilers and program slicers can often reproduce the control-flow of the original program successfully. Control Flow Flattening changes the control flow into a SWITCH statement, which prevents static control flow analysis.

White-box cryptography. White-box cryptography functions are used when there is a concern that an attacker may be able to monitor the application and extract one or more cryptographic keys embedded or generated by the application. In traditional cryptography, black-box attacks describe the situation where the attacker tries to obtain the key by knowing the algorithm and monitoring the inputs and outputs, but without the execution being visible. White-box cryptography addresses the much more severe threat model of content protection systems where the attacker can observe everything. Encryption and decryption are still required, but without exposing the cryptographic key. With proper design, applications can keep sensitive data either encrypted or transformed—or both—such that the original data is never exposed. All data operations will occur in a transformed state.

Integrity verification modifications. Integrity Verification is a more secure variation of code signing that ensures trust on an untrusted host. It provides a secure method of validating the integrity of an application and can also ensure the integrity of external modules interacting with that application, including components of the operating system. Integrity Verification ensures that software cannot be tampered with—either statically or dynamically—without detection. This significantly raises the bar in tamper resistance because an attacker must not only reverse-engineer a program and make modifications to the binary, but must also defeat the integrity checking as well.

Anti-debugging modifications. Any debugging or diagnostic functionality running in an application's environment aids end-users whose intent is to reverse engineer or subvert the normal functionality of the deployed application. Anti-debug techniques permit the detection of debuggers running in the same environment as the application. If detected, the application can take action to either de-activate the debugger or stop running.

Secure packager/loader. In this technique, a mini-application called a Secure Packager/Loader intercepts user or application calls to a target file during run-time. The Secure Packager/Loader must first validate the trigger event before it unpacks and executes the called target file. Encrypting the target executable or DLL as well makes it hard for an attacker to statically analyze the file in storage.

Of course, any known high-level obfuscation and/or security techniques can be used to obfuscate and/or secure the high-level source codes described herein.

At step 204, the custom VM source code (which has optionally been obfuscated in a known manner) is compiled with one or more target system compilers to generate one or more instances of the custom VM. Each of these instances of the custom VM are configured to run on one of the one or more target systems. For example, if there are two target systems, then the custom VM source code can be compiled with two different target system compilers to two generate two instances of the custom VM, one for each target system.

At step 205, application source code is optionally obfuscated, such as through the high level obfuscation techniques described earlier. At step 206, custom application bytecode is generated from the application source code, or a portion of the application source code, based at least in part on the custom VM definition. The custom application bytecode is bytecode which is configured to run on the custom VM. For example, the custom application bytecode can contain one or more instructions that can only be interpreted by a custom interpreter that is part of the custom VM and not by an interpreter of a standard Java VM.

At step 207, the custom application bytecode and the one or more instances of the custom VM are packaged into an installable application. This can be in the form of a package file, such as an Android application package file (APK).

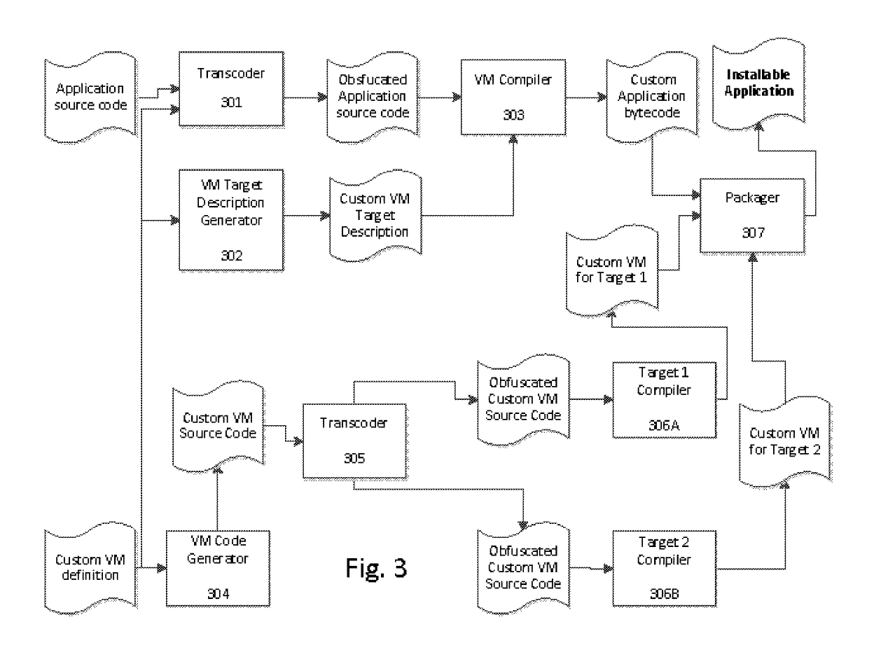

FIG. 3 illustrates a process flow diagram for generating the installable application, including the custom application bytecode and the one or more instances of the custom VM. As shown in the diagram, transcoder 301 can use the custom VM definition and the application source code to generate obfuscated application source code. Transcoder 301 can use the custom VM definition to generate appropriate high level constructs for execution on the custom VM specified by the custom VM definition. Alternatively, the obfuscated application source code can be generated without the custom VM definition based only on the application source code. This step can also be omitted so that the application source is not obfuscated.

The VM target description generator 302 also receives the custom VM definition and converts it into a custom VM target description that is suitable for use in the back-end of VM compiler 303. For example, the custom VM definition can be a file which includes a set of properties that define the custom VM. The properties can relate to any aspect of the custom VM, such as capacity, OS, boot options, disks, memory, networks, input/output, constraints, requirements, expression syntax, classes, instruction sets, instruction syntax, specifications, etc. The properties in the custom VM definition can then be used to adjust, select, or map the settings in the custom VM target description which is used in the back-end of the VM compiler 303.

For example, a custom VM definition may define a custom bytecode instruction which is not part of a standard JVM instruction set. The VM target description generator can receive this custom VM definition and convert it to a custom VM target description which includes the custom bytecode instruction in an instruction set portion of the custom VM target description.

The VM compiler 303 processes the (optionally obfuscated) application source code, or a portion of the application source code, to generate custom application bytecode which is configured for execution on the custom VM specified by the custom VM definition. The VM compiler 303 can generate the custom application bytecode based at least in part on the custom VM target description received from the VM target description generator 302.

The custom VM definition is additionally input to the VM code generator 304 which generates the custom VM source code corresponding to the custom VM, which includes the custom VM interpreter.

In order to protect the custom VM source code against white-box attacks, transcoder 305 can optionally perform high level obfuscation on the custom VM source code, or portions of the custom VM source code.

The (optionally obfuscated) custom VM source code is sent to target compilers 306A and 306B corresponding to two different target platforms. For each target platform, the target compilers 306A and 306B process the custom VM source code to generate two instances of the custom VM, one corresponding to each target platform. FIG. 3 illustrates two target platforms, but in practice the number of target platforms may be larger or smaller. This means that the protection scheme addresses the portability of the custom VM to all the target platforms and the application source code developer does not need to do this.

Packager 307 packages the custom VM for target platform 1, the custom VM for target platform 2, and the custom application bytecode into an installable application. As discussed earlier, the package can be in a standard format, such as an APK.

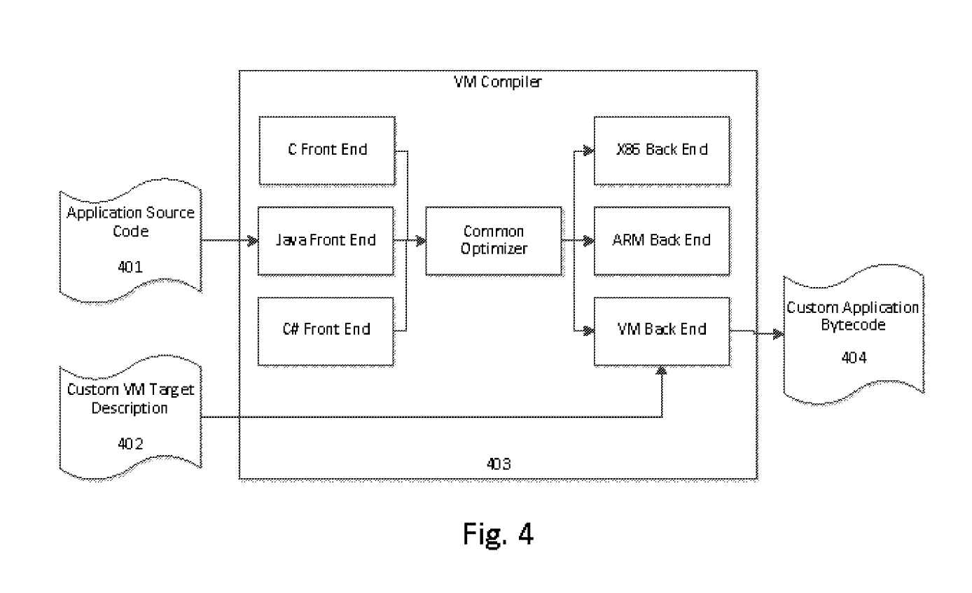

Referring to FIG. 4, the architecture of the VM compiler will now be described. The VM compiler 403 receives the application source code 401 and uses the custom VM target description 402 to control the VM back end that converts an intermediate representation used in the common optimizer into the custom application bytecode 404.

This architecture allows for a compiler that can easily support a broad range of target virtual machines. Alternatively, the VM compiler can utilize the custom VM target description to modify a part of an existing VM compiler component (such as a macro pre-processor, compiler, and/or linker). Such an approach is less flexible in terms of potential customization, but requires less implementation efforts for effecting specific changes to an existing VM.

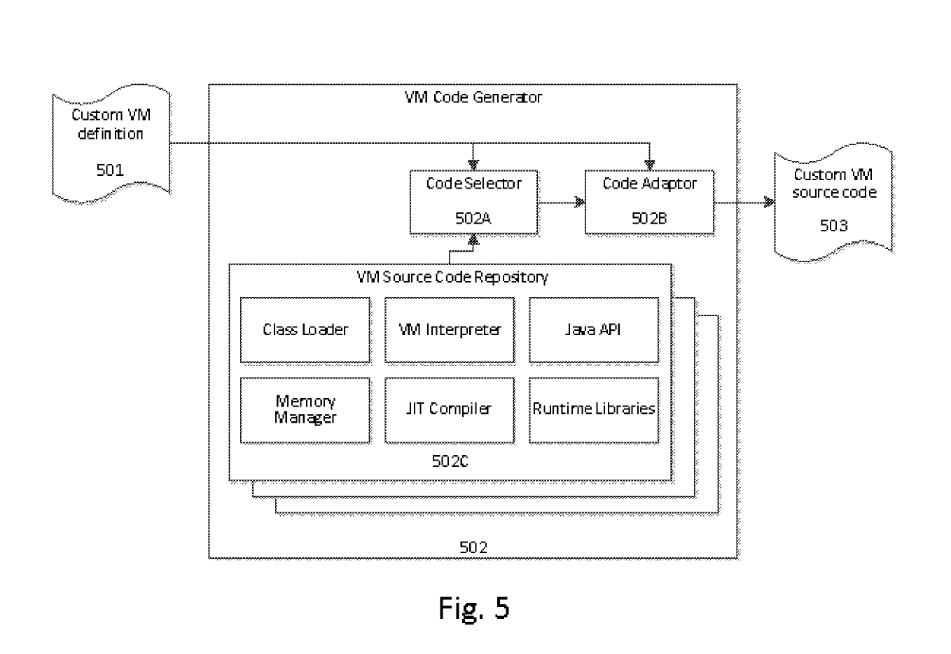

The generated custom application bytecode requires a custom VM (including a custom VM interpreter) corresponding to the custom VM definition. As described earlier, the source code to implement this custom VM is generated by the VM code generator. A schematic diagram of the VM code generator is shown in FIG. 5.

The code selector 502A of the VM code generator 502 uses the custom VM definition 501 to select VM source code from a VM source code repository 502C. The selected code is modified by the code adaptor 502B to generate the custom VM source code. This enables the VM code generator 502 to select, combine and/or amend existing source code fragments. The custom VM definition 501 can also specify additional functionality for the custom VM which the VM code generator 502 uses when generating custom VM source code 503. Since the custom VM definition is also used by the VM compiler when compiling the application source code, the corresponding custom application bytecode is able to utilize the additional functionality. Examples of additional functionality will be described in greater detail with respect to specific transformations that can be implemented by the custom VM.

Since each of the custom VM components (including custom interpreter components) can implement additional functions that the generated custom application bytecode is configured to use, the custom application bytecode and the custom VM are effectively linked. An attacker would therefore have to reverse engineer both the custom VM and the custom application bytecode image in order to modify the bytecode for execution on a different VM having a different VM interpreter.

The following sections provide examples of additional functionality for each of the custom VM components that will make up the custom VM and which are generated using source code selected from the source code repository 502C.

A class loader component handles the loading of the application bytecode. Additional functions for the class loader can include loading of transformed application bytecode (corresponding to the custom application bytecode), on-demand loading of transformed application bytecode, and instruction address transformations. Each of these functions are described in greater detail below.

Loading of transformed application bytecode. In this case, the custom application bytecode is bytecode that has been transformed to protect against reverse engineering. During the loading an inverse transformation is applied. The result is the loading of the original application bytecodes into the custom VM memory. An example of a bytecode transformation is encryption, in which case the class loader of the custom VM would decrypt the bytecode when loading.

On-demand loading of transformed application bytecode. In this case only a part of the custom application bytecode is loaded. When execution transfers to custom application bytecode that has not yet been loaded, the custom VM uses the class loader to load a next part of the custom application bytecode so execution can continue. As the loaded set of custom application bytecodes depends on program execution, it is hard for an attacker to observe the entire custom application bytecode image in the custom VM memory. This run-time protection extends the static protection provided by the loading of transformed application bytecodes.

Instruction Address Transformations. In this case, the class loader stores the custom application bytecode at a different location. At compile time, a correction is made for the fact that the custom application bytecode is stored at a different location. Address transformations can be applied to a selected part of the application bytecode only.

A memory manager component allocates and manages data structures stored in the custom VM memory. Additional functions for this component are listed below.

The memory manager can move data to a different location. Only application bytecode that knows about this additional feature can correctly calculate the location of an instance of the data structure before using it.

The memory manager can transform data in the memory. Only application bytecode that knows about this additional feature will be able to operate on such transformed data.

The memory manager can also verify that the memory structures are accessed as expected from application bytecode that was generated by a suitable compiler. Any memory accesses outside of the normal address range or with an incorrect access pattern can result in the memory manager triggering some defensive measure. Special data structures can be used to control the access pattern verifier in the memory manager.

A custom VM interpreter component performs a fetch-execute loop for the custom application bytecode instructions. The custom VM interpreter can be adapted to support additional functionality, such as additional instructions that are not part of the standard instruction set.

Some examples obfuscation techniques, application bytecode generation, and transformations which can be implemented by the custom VM and the custom application bytecode will now be described with reference to the figures.

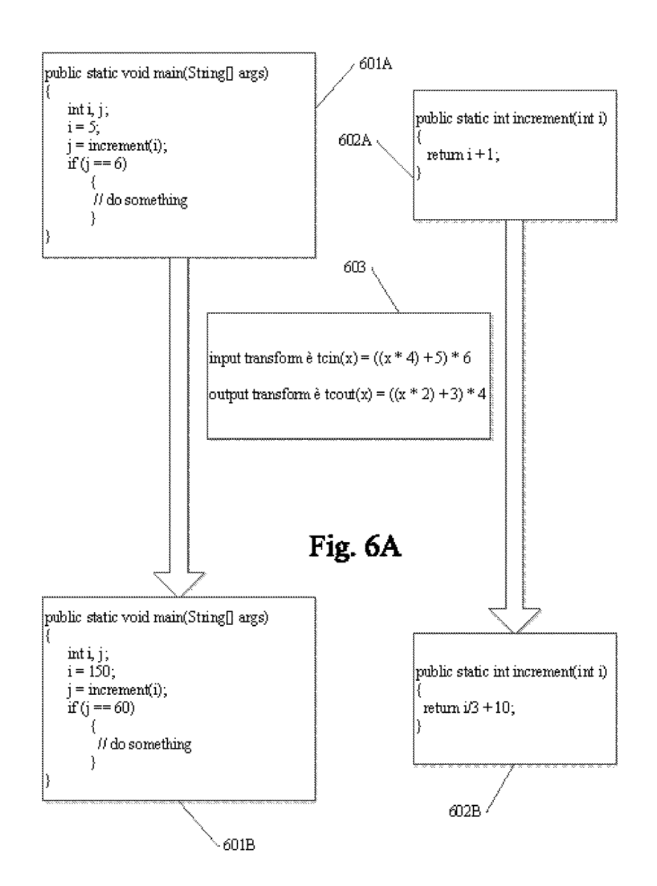

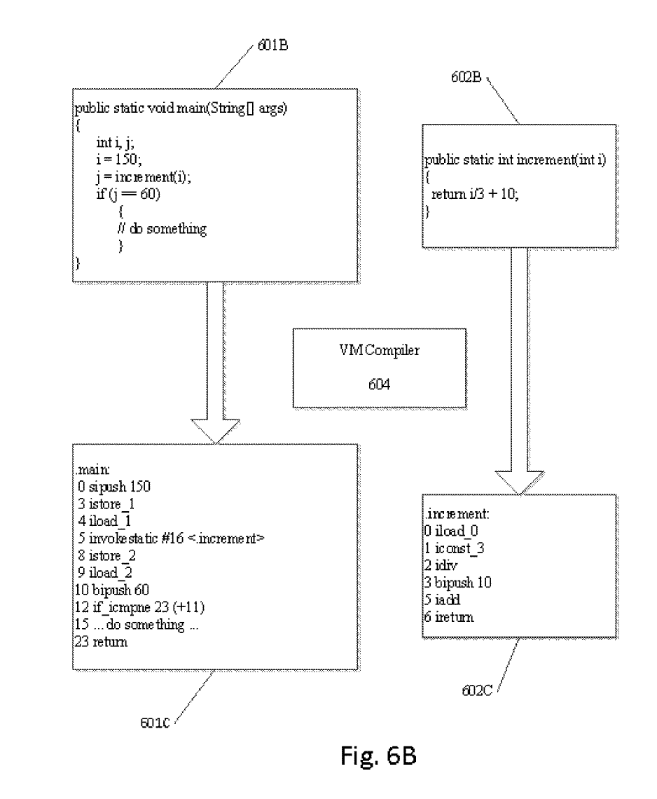

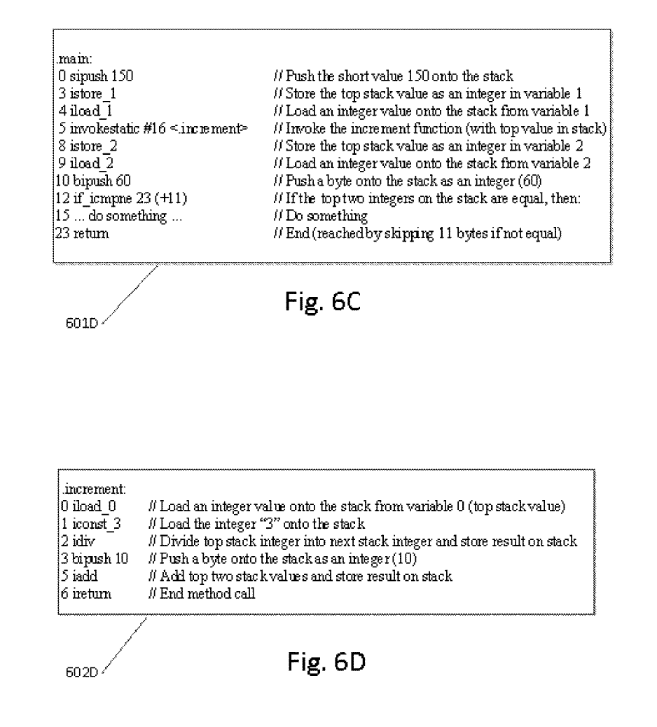

FIG. 6A shows how application source code expressed in the Java notation is converted into an obfuscated form. The application source code includes a main function 601A and an increment function 602A. The transformation indicated by 603 is applied to the source code and transforms all input stream values (“5” in the main function 601A) according to the first equation, all output stream values (“6” in the main function 601A) according to the second equation, and modifies the returned values in the increment function based on changes to the values in the main function to keep the same execution flow. The resulting obfuscated application source code includes the obfuscated main function 601B and the obfuscated increment function 602B. To provide an example of a transformation, since “5” in the main function 601A is an input stream value, the resulting transformation is ((5*4)+5)*6=150.

FIG. 6B illustrates the transformation of the obfuscated application source code to application bytecode. Specifically, when the obfuscated main function 601B is compiled by the VM compiler 604, application bytecode 601C is produced. Additionally, when the obfuscated increment function 602B is compiled by the VM compiler, application bytecode 602C is produced.

FIG. 6C illustrates the application bytecode corresponding to the obfuscated main function, along with comments relating the actions performed by each instruction in the bytecode 601D. For example, the instruction at byte 12 compares the two integers on the stack. If they are not equal, then execution branches to the byte indicated by the branch offset in the instruction (+11), resulting in execution of the byte at address 23. Also shown is the application bytecode corresponding to the obfuscated increment function, along with comments relating the actions performed by each instruction in the bytecode 602D.

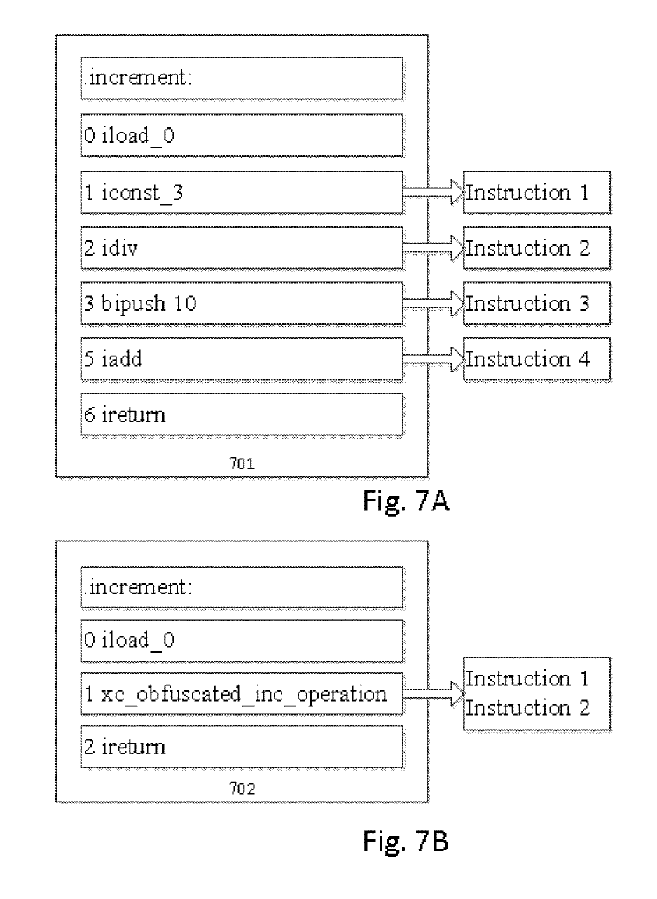

FIGS. 7A-7B illustrate an example of special instructions which can be implemented using a custom VM interpreter and custom application bytecode. FIG. 7A illustrates bytecode 701 corresponding to the obfuscated increment function previously discussed. As shown in the figure, each of the bytecode instructions at byte addresses 1, 2, 3, and 5 (corresponding to the steps of initializing a constant value “3” and pushing it on the stack, dividing the top two numbers on the stack and storing the result on the stack, pushing the value 10 onto the stack, and adding the top two numbers on the stack) must be interpreted by the JVM interpreter and mapped to native instructions by the JVM, resulting in four instructions required to perform these steps.

Turning to FIG. 7B, custom application bytecode 702 corresponding to the same obfuscated increment function is shown. In the custom application bytecode, the four instructions which were used to divide by 3 and 10 to a value have been replaced by a single complex instruction “xc_obfuscated_inc_operation” which is specifically targeted to represent the increment function in the transformed domain specific to the example. The complex instruction can take the top value on the stack, divide it by 3, and add 10 to the result, storing the result on the stack. This reduces the total number of necessary instructions by removing the need to read and write intermediate values from and to the custom VM's virtual stack.

A custom VM interpreter in a custom VM which corresponds to the custom application bytecode can include the complex instruction “xc_obfuscated_inc_operation” in its instruction set, so that when it is encountered in the custom application bytecode, the instruction can be properly executed. By contrast, if this instruction set were run on a standard JVM, the standard JVM interpreter would not be able to interpret the complex instruction and the application would not execute correctly.

This coordination between the custom VM and the custom application bytecode can be implemented based on the custom VM definition and the processes described earlier. By pairing non-standard functionality and obfuscation features in a custom VM with obfuscated custom application bytecode, the security of the application bytecode is greatly enhanced, since both the custom VM and the corresponding custom application bytecode would have to be reverse engineered to duplicate the application.

The custom VM interpreter can also verify that the instruction sequences are as expected from the custom VM bytecode execution. Any instruction patterns outside of the normal range can result in the custom VM interpreter triggering some defensive measure. Special bytecode instructions or instruction sequences can be used to control the instruction pattern verifier in the custom VM interpreter. This control can happen as a side effect to normal bytecode processing.

Another technique which can be used is the implementation of application bytecode transformations in the fetch-execute cycle of the custom VM Interpreter. This transformation can be independent from similar functionality in the custom VM class loader component.

The custom VM interpreter also can support special bytecode instructions to deal with additional functions implemented by other parts of the custom VM (e.g. in the Memory Manager or the custom VM class loader).

Another component of the custom VM is the JIT compiler component which provides a way to increase performance for the processing of the custom application bytecode. Additional functions for this component are listed below.

The JIT compiler can support an extended set of bytecodes that are present in the loaded code. This is similar to the support of new instructions in the custom VM Interpreter as described earlier.

The JIT compiler can generate native instructions to verify that the custom application bytecode instruction sequences are as expected for the custom application bytecode execution. Any instruction patterns outside of the normal range can result in the custom VM triggering some defensive measure. The compiled code can exchange instruction tracing information with other parts of the custom VM in order to efficiently record the execution progress and to detect any execution patterns that are outside the expected range.

The JIT compiler can be extended to deal with custom application bytecodes that have been transformed when compiling them to native instruction sequences. This transformation can be independent from similar functionality in the custom VM class loader or the memory manager

The JIT compiler also can generate native code in a way that makes use of additional functions implemented by other parts of the custom VM (e.g. in the memory manager or the custom VM class loader).

Additional components of the custom VM include the custom VM API and the runtime library module, which are a standard set of functions that the custom VM uses to provide access to common high-level operations in an optimized way. These operations typically are related to I/O tasks. Additional functions for these similar components are listed below.

The VM API and/or the runtime library can support an extended set of functions to support applications.

The VM API and/or the runtime library can support a transformed set of functions to support applications. Transformed means that either the entry point (library routine name or API function name) or the parameters provided as part of the call are mapped to another domain. The application needs to know about these transformations in order to activate the intended functions. For example, the custom application bytecode can be compiled using the custom VM definition to utilize the transformed functions.

The VM API and/or the runtime library can also modify parameters in the library that lock the proper operation of a support function to a specific hardware platform. The locking can be configured at installation, during first execution, or as part of the acquisition process from an application store.

Some additional examples of custom application bytecode transformations which can be utilized by the custom VM will now be described.

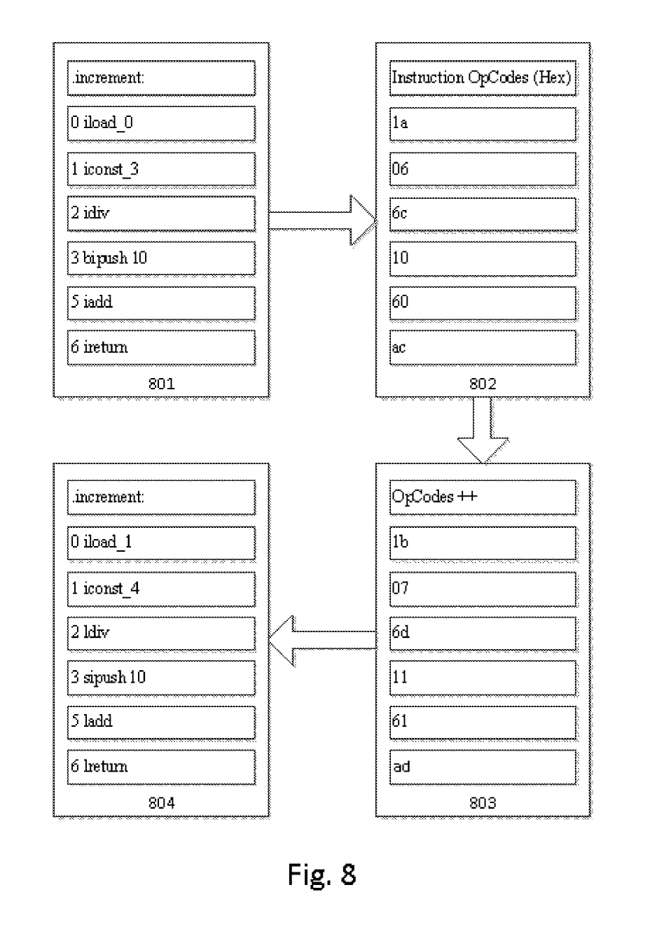

FIG. 8 illustrates an encryption transformation performed on the application bytecode corresponding to the previously discussed increment function. This transformation can be performed by the VM compiler during compilation of the application source code and can be based on information in the custom VM definition file. The original application bytecode 801 corresponds to a set of relevant opcodes as shown at 802. Opcodes are two digit hexadecimal representations of the instructions in the bytecode, with each opcode corresponding to a byte and representing a unique instruction. A transformation can be performed to adjust the opcodes for each instruction by a constant value (with the exception that any transformed opcode cannot exceed the one byte size limit and would instead become the first opcode, so ff would become 00).

In FIG. 8, the opcodes for each instruction are incremented by one, resulting in the transformed set of opcodes 803. The instructions corresponding to these transformed opcodes are shown at 804. This set of instructions 804 can be considered the custom application bytecode and will only execute on a custom VM which is aware of the transformation so that it can perform the inverse transformation prior to execution. As before, the coordination between the custom VM and the custom application bytecode can be based on the custom VM definition file and can be facilitated using the process described earlier with regard to FIGS. 2-3.

In this example, the inverse transformation would be to subtract one from each of the opcodes for each of the instructions prior to interpreting and executing the instructions. If the custom application bytecode were to be run on a VM which was not aware of the transformation, the incorrect instructions would be executed, likely resulting in errors and/or a crash of the application.

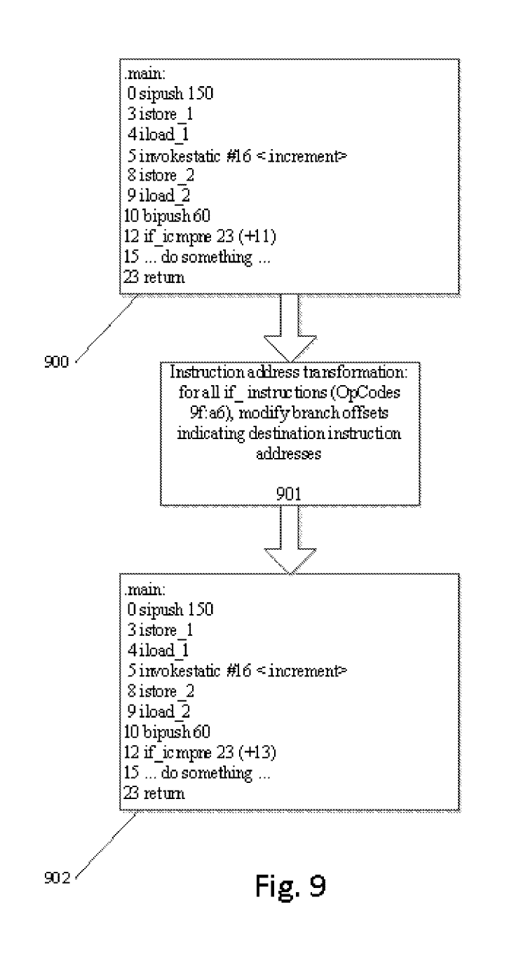

FIG. 9 illustrates an instruction address transformation performed on the application bytecode corresponding to the previously discussed main function. The application bytecode 900 includes an if_icmpne instruction at address 12 which branches to address 23 if the condition is not fulfilled. Address 23 contains the return instruction which ends the main function.

A transformation 901 can be performed on this instruction to modify the branch offset parameter of the if_icmpne to branch to an incorrect instruction address. As shown in FIG. 9, the custom application bytecode 902 after the transformation 901 includes an if_icmpne instruction at address 12 which branches to address 25 if the condition is not fulfilled.

The custom application bytecode 902 will only execute on custom VM which is aware of the transformation so that it can perform the inverse transformation prior to execution. As before, the coordination between the custom VM and the custom application bytecode can be based on the custom VM definition file and can be facilitated using the process described earlier with regard to FIGS. 2-3.

In this example, the inverse transformation would be to subtract two from the branch offset for the if_icmpne instruction prior to interpreting and executing the instruction. If the custom application bytecode were to be run on a VM which was not aware of the transformation, execution could transfer to the incorrect branch address and the application would likely freeze since the main function could not be ended.

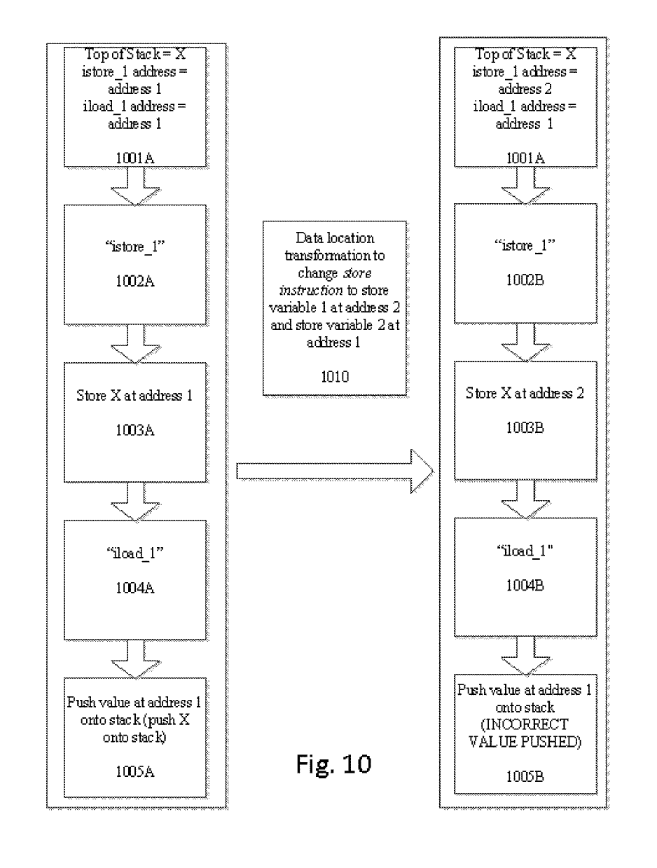

FIG. 10 illustrates an example of a data location transformation which can be implemented by a memory manager of a custom VM.

The left column corresponds to a standard VM, such as the JVM, and illustrates the processing flow for the instructions “istore_1” and “iload_1” which store a value into variable 1 and load a value from variable 1, respectively. As indicated at 1001A, the top value in the stack is an integer X and the instructions istore_1 and iload_1 are both associated with address 1.

When the istore_1 instruction is executed 1002A, the top value in the stack (in this case X) is stored at memory address 1, as indicated at 1003A. When the iload_1 instruction is executed 1004A, the value at address 1 is pushed onto the stack. This results in X being pushed onto the stack, as indicated at 1005A.

In a custom VM, the memory manager can implement a data location transformation 1010 which switches the addresses associated with the istore_1 and istore_2 commands, resulting in istore_1 commands being associated with address 2 and istore_2 commands being associated with address 1. This data location transformation can affect only the istore commands, with the iload commands being unaffected.

Referring to FIG. 10, the right column corresponds to a custom VM which has implemented the above-mentioned data location transformation. As indicated at 1001B, the top value in the stack is still integer X, and the address associated with iload_1 is still address 1, but the address associated with istore_1 is now address 2.

When the istore_1 instruction is executed 1002B, the top value in the stack (in this case X) is stored at memory address 2, as indicated at 1003B. When the iload_1 instruction is executed 1004B, the value at address 1 is pushed onto the stack. As indicated at 1005B, this is the incorrect value as the value for variable 1 was stored at address 2 and not address 1. Since the application bytecode is not aware of the data location transformation, unaltered application bytecode will not execute properly on the custom VM.

In order to properly execute an application on this custom VM, the custom application bytecode would have to be aware of the transformation and be modified accordingly. For example, when the VM compiler is compiling the application source code, the custom VM definition can be used to switch the iload_1 and iload_2 instructions so that the correct values are loaded when those instructions are run. In this case, that would mean replacing the instruction iload_1 in the application bytecode with iload_2 to generate the custom application bytecode. This coordination between the custom VM and the custom application bytecode can be based on the custom VM definition file and can be facilitated using the process described earlier with regard to FIGS. 2-3.

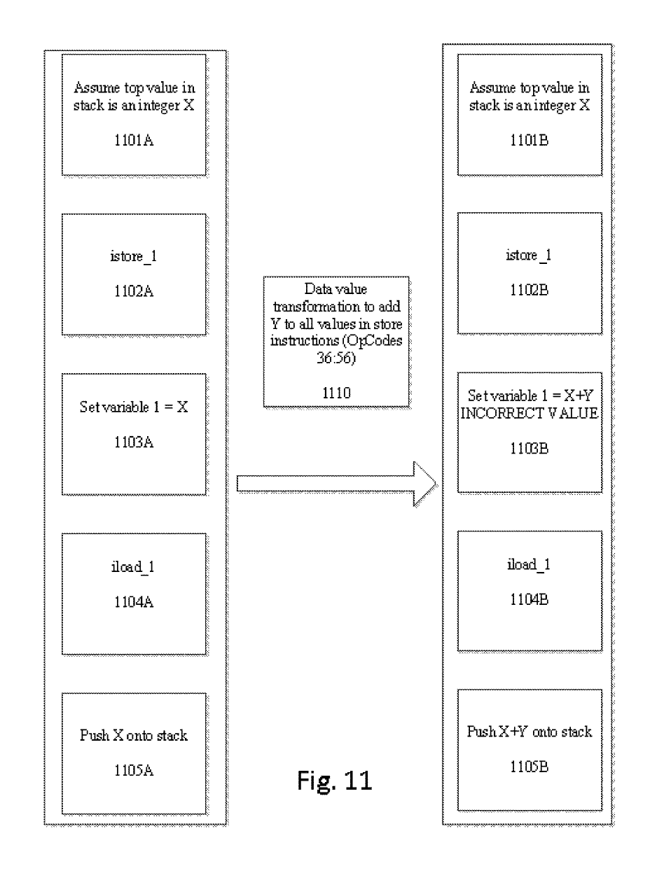

FIG. 11 illustrates an example of a data value transformation which can be implemented by a memory manager of a custom VM. As the memory addresses of each of the variables in the VM are not pertinent to this example, the istore and iload instructions will be discussed without reference to specific memory addresses.

The left column corresponds to a standard VM, such as the JVM, and illustrates the processing flow for the instructions “istore_1” and “iload_1” which store a value into variable 1 and load a value from variable 1, respectively. As indicated at 1101A, the top value in the stack is an integer X.

When the istore_1 instruction is executed 1102A, variable 1 is set to the top value in the stack (in this case X), as indicated at 1103A. When the iload_1 instruction is executed 1104A, the value of variable 1 is pushed onto the stack. This results in X being pushed onto the stack, as indicated at 1005A.

In a custom VM, the memory manager can implement a data value transformation 1110 which automatically adds value Y to all of the values stored in a variable when executing store instructions.

Referring to FIG. 11, the right column corresponds to a custom VM which has implemented the above-mentioned data value transformation. As indicated at 1101B, the top value in the stack is still integer X.

When the istore_1 instruction is executed 1102B, variable 1 is set to the value X+Y, as indicated at 1103B. When the iload_1 instruction is executed 1104B, the value X+Y is pushed onto the stack. As indicated at 1105B, this is the incorrect value as the value originally at the top of the stack was just X. Since the application bytecode is not aware of the data value transformation, the unaltered application bytecode will not execute properly on the custom VM.

In order to properly execute an application on this custom VM, the custom application bytecode would have to be aware of the transformation and be modified accordingly. For example, when the VM compiler is compiling the application source code, the custom VM definition can be used to add instructions to compensate for the addition of Y to the stored values of all variables. These instructions can effectively subtract Y from all values that are loaded from variables. For example, after a value is loaded from a variable to the stack, a constant Y can be added to the stack and then an instruction can subtract Y from the previously loaded value and store the result on the stack. In this case, the final value on the stack would be the same as if the data value transformation of adding Y did not occur.

This coordination between the custom VM and the custom application bytecode can be based on the custom VM definition file and can be facilitated using the process described earlier with regard to FIGS. 2-3.

As described in the examples above, generating the custom application bytecode from the application source code can include generating application bytecode from the application source code and performing a first transformation on the application bytecode to generate the custom application bytecode. Additionally, the custom VM definition can specify a second transformation to be applied to bytecode executed on the custom VM, the second transformation being based on the first transformation. This second transformation can be performed by the custom VM that is generated from the custom VM definition.

As shown in the examples, many variations of transformations are possible. The first transformation can be encryption of an instruction in the bytecode and the second transformation can be decryption of the instruction in the bytecode. The first transformation can be an adjustment of an instruction address associated with an instruction in the bytecode, and the second transformation can be a reverse adjustment of the instruction address associated with the instruction in the bytecode. The first transformation can be a replacement of a first instruction in the bytecode with a second instruction, and the second transformation can be a transformation of a memory location where data associated with the first instruction in the bytecode is stored, such that data associated with the second instruction is stored at the memory location previously corresponding to data associated with the first instruction. The first transformation can be an addition of one or more new instructions to the bytecode, and the second transformation can be a transformation of a data value which is stored in memory during execution of an instruction in the bytecode. In each of these examples, the second transformation can be used to compensate for the effects of the first transformation. Of course, these examples are provided for illustration only, and other transformation variations are possible.

Returning to the flowchart of FIG. 2, at the conclusion of that process, one or more instances of the custom VM are generated and can be distributed to users as part of the installable application. Each of these custom VM's can implement the customizations discussed herein and can be executed on the target platforms of users. A method for executing an application on a custom VM according to an exemplary embodiment is described below.

During execution of an application, custom application bytecode corresponding to an application can be loaded into a memory of the custom VM, with both the custom application bytecode and the custom VM being generated based at least in part on a custom VM definition corresponding to the custom VM.

Bytecode instructions, which are configured for the custom VM, can be executed on the custom VM. Additionally, one or more data values can be stored in the memory of the custom VM based at least in part on the one or more bytecode instructions.

The custom application bytecode can be bytecode that has been transformed by a first transformation which is based at least in part on the custom VM definition. In that situation, the custom application bytecode can be loaded by applying a second transformation to the custom application bytecode based on the first transformation to generate transformed application bytecode, the second transformation also being based at least in part on the custom VM definition and loading the transformed application bytecode into the memory of the custom VM.

The first transformation can be encryption of an instruction in the bytecode and the second transformation can be decryption of a corresponding instruction in the custom application bytecode. The first transformation can be an adjustment of an instruction address associated with an instruction in the bytecode, and the second transformation can be a reverse adjustment of an instruction address associated with a corresponding instruction in the custom application bytecode.

The custom application bytecode can also be loaded by loading a first portion of the custom application bytecode and loading a second portion of the custom application bytecode based at least in part on a determination that execution of the application has transferred to a portion of the custom application bytecode that is outside of the first portion.

Bytecode instructions in the custom application can be executed by interpreting some or all of bytecode instructions to identify one or more corresponding routines in a run time library and executing the one or more corresponding routines.

The bytecode instructions can be bytecode that has been transformed by a first transformation which is based at least in part on the custom VM definition. Interpreting the bytecode instructions can be performed by applying a second transformation to the bytecode instructions based on the first transformation to generate transformed bytecode instructions, the second transformation being based at least in part on the custom VM definition, and interpreting the transformed bytecode instructions to identify the one or more corresponding routines in the run time library. The bytecode instructions can be custom instructions specified in the custom VM definition, as discussed earlier.

Interpreting the bytecode instructions can also include determining a sequence of bytecode instructions in the plurality of bytecode instructions and triggering a defensive measure based at least in part on a determination that the sequence of bytecode instructions does not match an accepted sequence of bytecode instructions (such as a sequence of bytecode instructions indicating normal operation).

Bytecode instructions in the custom application bytecode can also be executed by converting at least one bytecode instruction in the one or more bytecode instructions into native machine code and executing the native machine code.

The bytecode instructions can include bytecode that has been transformed by a first transformation which is based at least in part on the custom VM definition. In this case, bytecode instructions can be converted by applying a second transformation to the bytecode instructions based on the first transformation to generate transformed bytecode instructions, the second transformation being based at least in part on the custom VM definition. The transformed bytecode instructions can then be converted into native machine code.

A sequence of the native machine code and a defensive measure can be triggered based at least in part on a determination that the sequence of the native machine code does not match an accepted sequence of native machine code.

As stated earlier, the bytecode instructions can include bytecode that has been transformed by a first transformation which is based at least in part on the custom VM definition. In this case, the one or more data values can be stored in the memory of the custom VM by applying a second transformation to a memory location where data associated with the at least one bytecode instruction is stored, the second transformation being based at least in part on the custom VM definition.

Bytecode instructions can include bytecode that has been generated based on a first transformation which itself is based at least in part on the custom VM definition. In this case, a second transformation can be applied to at least one data value in the one or more data values which are stored in the custom VM memory, with the second transformation also being based at least in part on the custom VM definition.

When storing the data values in the memory of the custom VM, a sequence of VM memory addresses corresponding to the plurality of data values can be determined. If this sequence of VM memory addresses does not match an accepted sequence of VM memory addresses a defensive measure can be triggered.

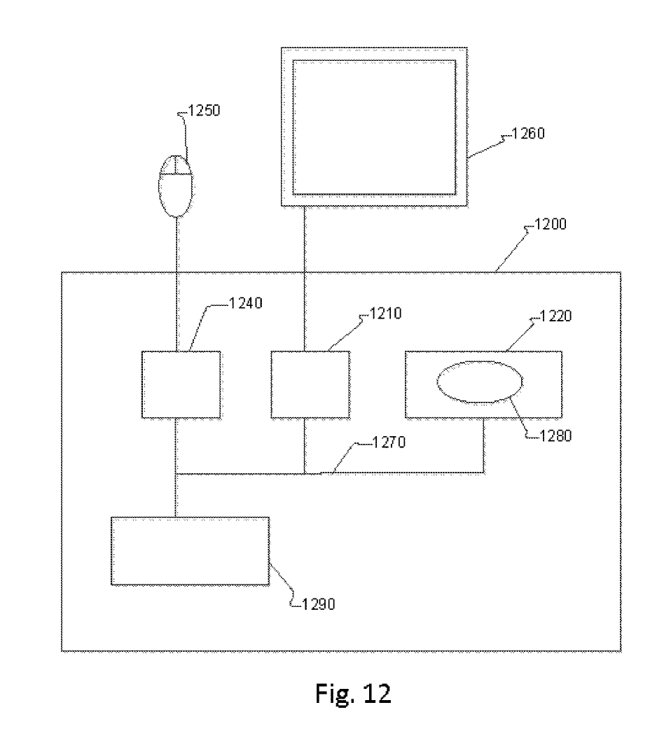

One or more of the above-described techniques can be implemented in or involve one or more computer systems. FIG. 12 illustrates a generalized example of a computing environment 1200. The computing environment 1200 is not intended to suggest any limitation as to scope of use or functionality of a described embodiment.

With reference to FIG. 12, the computing environment 1200 includes at least one processing unit 1210 and memory 1220. The processing unit 1210 executes computer-executable instructions and may be a real or a virtual processor. In a multi-processing system, multiple processing units execute computer-executable instructions to increase processing power. The memory 1220 may be volatile memory (e.g., registers, cache, RAM), non-volatile memory (e.g., ROM, EEPROM, flash memory, etc.), or some combination of the two. The memory 1220 may store software instructions 1280 for implementing the described techniques when executed by one or more processors. Memory 1220 can be one memory device or multiple memory devices.

A computing environment may have additional features. For example, the computing environment 1200 includes storage 1240, one or more input devices 1250, one or more output devices 1260, and one or more communication connections 1290. An interconnection mechanism 1270, such as a bus, controller, or network interconnects the components of the computing environment 1200. Typically, operating system software or firmware (not shown) provides an operating environment for other software executing in the computing environment 1200, and coordinates activities of the components of the computing environment 1200.

The storage 1240 may be removable or non-removable, and includes magnetic disks, magnetic tapes or cassettes, CD-ROMs, CD-RWs, DVDs, or any other medium which can be used to store information and which can be accessed within the computing environment 1200. The storage 1240 may store instructions for the software 1280.

The input device(s) 1250 may be a touch input device such as a keyboard, mouse, pen, trackball, touch screen, or game controller, a voice input device, a scanning device, a digital camera, remote control, or another device that provides input to the computing environment 1200. The output device(s) 1260 may be a display, television, monitor, printer, speaker, or another device that provides output from the computing environment 1200.

The communication connection(s) 1290 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 1200, computer-readable media include memory 1220, storage 1240, communication media, and combinations of any of the above.

Of course, FIG. 12 illustrates computing environment 1200, display device 1260, and input device 1250 as separate devices for ease of identification only. Computing environment 1200, display device 1260, and input device 1250 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 1200 may be a set-top box, mobile device, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method executed by one or more computing devices for obfuscating execution of an application on a Virtual Machine (VM), the method comprising:
receiving, by at least one of the one or more computing devices, a custom VM definition corresponding to a custom VM;
generating, by at least one of the one or more computing devices, custom application bytecode from application source code based at least in part on the custom VM definition, wherein the custom application bytecode is configured to run on the custom VM;
generating, by at least one of the one or more computing devices, custom VM source code based at least in part on the custom VM definition;
compiling, by at least one of the one or more computing devices, the custom VM source code with one or more target system compilers to generate one or more instances of the custom VM, wherein the one or more instances of the custom VM are configured to run on the one or more target systems; and
packaging, by at least one of the one or more computing devices, the custom application bytecode and the one or more instances of the custom VM into an installable application.

2. An apparatus for obfuscating execution of an application on a Virtual Machine (VM), the apparatus comprising:
one or more processors; and
one or more memories operatively coupled to at least one of the one or more processors and having instructions stored thereon that, when executed by at least one of the one or more processors, cause at least one of the one or more processors to:
receive a custom VM definition corresponding to a custom VM;
generate custom application bytecode from application source code based at least in part on the custom VM definition, wherein the custom application bytecode is configured to run on the custom VM;
generate custom VM source code based at least in part on the custom VM definition;
compile the custom VM source code with one or more target system compilers to generate one or more instances of the custom VM, wherein the one or more instances of the custom VM are configured to run on the one or more target systems; and
package the custom application bytecode and the one or more instances of the custom VM into an installable application.

3. The apparatus of claim 2, wherein the instructions that, when executed by at least one of the one or more processors, cause at least one of the one or more processors to generate the custom application bytecode from the application source code further cause at least one of the one or more processors to:
convert the custom VM definition into a custom VM description; and
compile the application source code into custom application bytecode using a VM compiler, wherein the VM compiler generates the custom application bytecode based at least in part on the custom VM description.

4. At least one non-transitory computer-readable medium storing computer-readable instructions that, when executed by one or more computing devices, cause at least one of the one or more computing devices to:
receive a custom VM definition corresponding to a custom VM;
generate custom application bytecode from application source code based at least in part on the custom VM definition, wherein the custom application bytecode is configured to run on the custom VM;
generate custom VM source code based at least in part on the custom VM definition;
compile the custom VM source code with one or more target system compilers to generate one or more instances of the custom VM, wherein the one or more instances of the custom VM are configured to run on the one or more target systems; and
package the custom application bytecode and the one or more instances of the custom VM into an installable application.

5. The at least one non-transitory computer-readable medium of claim 4, wherein the instructions that, when executed by at least one of the one or more computing devices, cause at least one of the one or more computing devices to generate the custom application bytecode from the application source code further cause at least one of the one or more computing devices to:
convert the custom VM definition into a custom VM description; and
compile the application source code into custom application bytecode using a VM compiler, wherein the VM compiler generates the custom application bytecode based at least in part on the custom VM description.

6. A method executed by one or more computing devices for executing an application on a custom virtual machine (VM), the method comprising:
loading, by at least one of the one or more computing devices, custom application bytecode corresponding to the application into a memory of the custom VM, wherein both the custom application bytecode and the custom VM are generated based at least in part on a custom VM definition corresponding to the custom VM;
executing, by at least one of the one or more computing devices, one or more bytecode instructions in the custom application bytecode on the custom VM, wherein the one or more bytecode instructions are configured to run on the custom VM; and
storing, by at least one of the one or more computing devices, one or more data values in the memory of the custom VM based at least in part on the one or more bytecode instructions.

7. An apparatus for executing an application on a custom virtual machine, the apparatus comprising:
one or more processors; and
one or more memories operatively coupled to at least one of the one or more processors and having instructions stored thereon that, when executed by at least one of the one or more processors, cause at least one of the one or more processors to:
load custom application bytecode corresponding to the application into a memory of the custom VM, wherein both the custom application bytecode and the custom VM are generated based at least in part on a custom VM definition corresponding to the custom VM;
execute one or more bytecode instructions in the custom application bytecode on the custom VM, wherein the one or more bytecode instructions are configured to run on the custom VM; and
store one or more data values in the memory of the custom VM based at least in part on the one or more bytecode instructions.

8. The apparatus of claim 7, wherein the custom application bytecode comprises bytecode that has been transformed by a first transformation which is based at least in part on the custom VM definition and wherein the instructions that, when executed by at least one of the one or more processors, cause at least one of the one or more processors to load custom application bytecode further cause at least one of the one or more processors to:
apply a second transformation to the custom application bytecode based on the first transformation to generate transformed application bytecode, wherein the second transformation is also based at least in part on the custom VM definition; and
load the transformed application bytecode into the memory of the custom VM.

9. At least one non-transitory computer-readable medium storing computer-readable instructions that, when executed by one or more computing devices, cause at least one of the one or more computing devices to:
load custom application bytecode corresponding to an application into a memory of a custom virtual machine (VM), wherein both the custom application bytecode and the custom VM are generated based at least in part on a custom VM definition corresponding to the custom VM;
execute one or more bytecode instructions in the custom application bytecode on the custom VM, wherein the one or more bytecode instructions are configured to run on the custom VM; and
store one or more data values in the memory of the custom VM based at least in part on the one or more bytecode instructions.

10. The at least one non-transitory computer-readable medium of claim 9, wherein the custom application bytecode comprises bytecode that has been transformed by a first transformation which is based at least in part on the custom VM definition and wherein the instructions that, when executed by at least one of the one or more computing devices, cause at least one of the one or more computing devices to load custom application bytecode further cause at least one of the one or more computing devices to:
apply a second transformation to the custom application bytecode based on the first transformation to generate transformed application bytecode, wherein the second transformation is also based at least in part on the custom VM definition; and
load the transformed application bytecode into the memory of the custom VM.
